(19) United States
(12) Patent Application Publication
(10) Pub. No.: US 2025/0348839 A1
(43) Pub. Date: Nov. 13, 2025

(54) INVENTORY MANAGEMENT SYSTEM INCLUDING NETWORKED SCALE SYSTEMS WITH NETWORK-CONFIGURED SCALE DEVICES

(71) Applicant: Gravity Metric LLC, Salem, NH (US)

(72) Inventors: Scott Metzemaekers, Derry, NH (US); Lewis Arch, Derry, NH (US); Christopher Suprock, Warren, NH (US); David Metzemaekers, Andover, MA (US); Jeffrey Nichols, Pembroke, NH (US)

(21) Appl. No.: 19/201,282

(22) Filed: May 7, 2025

Related U.S. Application Data
(60) Provisional application No. 63/643,669, filed on May 7, 2024.

(51) Int. Cl. G06Q 10/087; G01G 19/00

(52) U.S. Cl. CPC G06Q 10/087; G01G 19/00

(57) ABSTRACT

An inventory management system includes networked scales that may be accessed and managed over a network. The inventory management system generally includes a plurality of networked scale systems at different measurement locations, such as different physical locations for inventory, connected to a network such as the internet. A network computing device may be used to access the networked scale systems and track inventory via the network. The networked scale systems include a plurality of networked scale devices connected in a daisy chain configuration to a 2-wire bus, for example, using a 10BASE-T1 standard, which carries data and powers the scale devices. The networked scale systems also include a media converter connected to the 2-wire bus and connecting the scale devices to the network, for example, using an Ethernet/TCP connection. The networked scale devices may thus be directly connected to the network (e.g., the internet), addressed independently, and easily accessed via the network for inventory management.

### CROSS-REFERENCE TO RELATED APPLICATIONS

The present application claims the benefit of U.S. Provisional Application Ser. No. 63/643,669 filed May 7, 2024, which is fully incorporated herein by reference.

### TECHNICAL FIELD

The present application relates generally to inventory management and, more particularly, to an inventory management system including networked scale systems with network-configured scale devices.

### BACKGROUND

Inventory management is critical in many industries to avoid costs associated with too much or too little inventory. Such inventory management may be useful, for example, in materials requirement planning (MRP) systems that businesses use to manage manufacturing processes. Some types of inventory, such as bulk products (e.g., nuts, bolts, etc.), may be tracked by weight using scales at the location of the inventory to measure the weight of the inventory. Measuring the weight of a particular type of inventory at a warehouse, for example, may allow a business to determine if the inventory needs to be replenished. Accurate tracking of this inventory plays an important role in proper inventory management; however, accurate tracking of inventory using scales to measure weight presents unique challenges because a type of inventory for a particular business may be spread across different physical locations.

Although networks may be used to access inventory data at different physical locations, significant human interaction is often needed to access the data from the scales. Existing systems for inventory management using scales provide limited interconnectivity and limited access to a large number of scales across different physical locations and thus may prevent automation of inventory management.

### SUMMARY

According to one aspect of the present disclosure, an inventory management system comprising a first networked scale system located at a first measurement location and at least a second networked scale system located at a second measurement location. The first networked scale system includes a first 2-wire bus configured to carry power and data at the first measurement location and a first plurality of scales connected to the first 2-wire bus in a daisy chain configuration. Each of the first plurality of scales is configured to provide scale data including at least weight data representing weight of inventory items measured at the first measurement location. A first media converter is connected to the first 2-wire bus and connected to a network via a first Ethernet connection. The first media converter is configured to provide the scale data to the network and configured to provide power to the first plurality of scales via the first 2-wire bus.

The second networked scale system includes at least a second 2-wire bus configured to carry power and data at the second measurement location and at least a second plurality of scales connected to the second 2-wire bus in a daisy chain configuration. Each of the second plurality of scales is configured to provide scale data including at least weight data representing weight of inventory items measured at the second measurement location. At least a second media converter is connected to the second 2-wire bus and connected to the network via a second Ethernet connection. The second media converter is configured to provide the scale data to the network and configured to provide power to the second plurality of scales via the second 2-wire bus.

The inventory management system also comprises a network computing device connected to the network. The network computing device includes a non-transitory machine-readable storage medium that includes instructions that, when executed by processor circuitry included in a portable electronic device, cause the processor circuitry to: provide a user interface (UI) to allow a user to access the scale data; and track inventory of one or more inventory items based on the scale data.

According to another aspect of the present disclosure, a networked scale system includes a 2-wire bus configured to carry power and data using a 10BASE-T1 standard and a plurality of scales connected to the 2-wire bus in a daisy chain configuration. Each of the scales includes at least one sensor for sensing a mass of an item, an upstream connection connected to the 2-wire bus for receiving power and data from upstream on the 2-wire bus, and a downstream connection connected to the 2-wire bus for providing power and data downstream on the 2-wire bus. The networked scale system further includes a media converter including at least one 10BASE-T1 port connected to the 2-wire bus and at least one Ethernet port configured to be connected to an Ethernet connection. The media converter converts between standard Ethernet and 10BASE-T1 and provides power to the plurality of scales over the 2-wire bus.

According to a further aspect of the present disclosure, a network configured scale device includes at least one sensor for sensing a mass of an item and for generating analog sensor signals representative of the mass of the item, an analog to digital converter (ADC) for converting the analog sensor signals to digital sensor signals representative of the mass of the item, and a processor for processing the digital sensor signals to produce at least weight data including a measured weight of the item as determined by the sensor. The network configured scale device also includes an upstream connection configured to be connected to a 2-wire bus that carries power and data using a 10BASE-T1 standard and a downstream connection configured to be connected to the 2-wire bus. The network configured scale device further includes an Ethernet transceiver connected between the processor and the upstream connection and the downstream connection. The Ethernet transceiver is configured to transmit and receive data via the upstream connection and the downstream connection using a 10BASE-T1 standard. At least one power converter is configured to receive power from the upstream connection and configured to supply power to at least the ADC, the processor and the Ethernet transceiver.

### BRIEF DESCRIPTION OF THE DRAWINGS

Reference should be made to the following detailed description which should be read in conjunction with the following figures, wherein like numerals represent like parts.

FIG. 1 is a functional block diagram illustrating an inventory management system including networked scale systems at different measurement locations, consistent with embodiments the present disclosure.

FIG. 2 is a functional block diagram illustrating a networked scale system, consistent with embodiments of the present disclosure.

FIG. 3 is a functional block diagram illustrating a network-configured scale for use in the networked scale system shown in FIG. 2 and the inventory management system shown in FIG. 1, consistent with an embodiment of the present disclosure.

FIG. 4 is a schematic diagram illustrating electronic components and electrical connections in an embodiment of the network-configured scale for use in the networked scale system shown in FIG. 2 and the inventory management system shown in FIG. 1.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

An inventory management system, consistent with embodiments of the present disclosure, includes networked scales that may be accessed and managed over a network. The inventory management system generally includes a plurality of networked scale systems at different measurement locations, such as different physical locations for inventory, connected to a network such as the internet. A network computing device may be used to access the networked scale systems and track inventory via the network. The networked scale systems include a plurality of networked scale devices connected in a daisy chain configuration to a 2-wire bus, for example, using a 10BASE-T1 standard, which carries data and powers the scale devices. The networked scale systems also include a media converter connected to the 2-wire bus and connecting the scale devices to the network, for example, using an Ethernet/TCP connection. The networked scale devices may thus be directly connected to the network (e.g., the internet), addressed independently, and easily accessed via the network for inventory management.

The inventory management system may be implemented as a low-cost network-based inventory management system that determines the quantity of a product to be inventoried based on the weight of the product as measured by one of the scales. The network connected scales in the inventory management system may be managed by an inventory management application (e.g., a web app). The inventory management application may be hosted by any hosting service including an internet-capable hosting service such as Amazon Web Services.

The inventory management system may connect the array of network connected scales through an Ethernet switch, e.g., a Power over Ethernet (PoE) switch, without the use of an intermediate computer or edge gateway. In some embodiments, a media converter may connect the network connected scales directly to the internet through an Ethernet switch and provide an internet connection to the scales in a daisy-chain configuration. The system provides a simple method to manage a large array of internet connected scales while using low overhead in an existing information technology (IT) infrastructure. The media converter may provide both power and data to the connected scales over a 2-wire interface, such as 10BASE-T1S.

The media converter may convert standard Ethernet (e.g., PoE) into 10BASE-T1S and may provide power to downstream scales from a PoE Ethernet connection. The media converter may thus allow the downstream scales to interface directly with the internet without the need for an intermediate connection or edge gateway, which reduces the cost and complexity of the scales. The number of scales the media converter may connect to is only limited by the power requirements of the scales and the power transmitting capacity of the PoE switch.

The network computing device may be a host including a non-transitory machine-readable storage medium that includes instructions that, when executed by processor circuitry, provide a user interface (UI), such as a graphical user interface (GUI), to a user on a connected user device, e.g., a personal computer (PC), a smartphone, a tablet computer, etc. The content of the UI may be generated by the inventory management application using weight data from the connected scales to determine quantities of each monitored product, regardless of the location or number of locations where the product is located. In an embodiment, the inventory management application may virtually link multiple scales, regardless of the locations of the individual scales, into a virtual single scale to track inventory of a particular product across a plurality of locations. For example, 4 scales may be used with one scale on each corner of a pallet containing inventory and the 4 scales may be linked to provide a single measurement value to the user. The inventory management application may also combine measurement values from a group of scales regardless of physical location and present the combined measurement values from that group of scales to the user. For example, the inventory management application may be used to track the same SKU from multiple locations by grouping the scales being used to weigh inventory with that same SKU.

The network connected scales in an inventory management system may be located in one or more facilities to manage inventory by tracking the weight of the product. The inventory management system has the ability to manage inventory for items stored in multiple locations since a product may be stored in various locations throughout the facility. For example, in a factory the inventory may be located on the production floor, a warehouse area, and/or a receiving dock for items that have not yet been moved into inventory. In addition, since the scales are managed over a network, inventory of a product may be managed across multiple locations within a facility or facilities that are connected to the network. In some embodiments, the scales are connected to the internet and inventory of a product may include multiple locations that are separated by a distance but are accessible over the internet, such as a factory and a remote warehouse, or multiple warehouses and/or retail locations.

The disclosed inventory management system provides simplicity in managing a large array of network connected scales (and optionally other objects), while requiring a low overhead from the existing standard company IT infrastructure. The networked scale systems in the inventory management system advantageously provide both power and data over a two-wire interface. The two-wire interface may include a 2-wire twisted pair using a 10BASE-T1 standard such as a single 2-wire twisted pair using 10BASE-T1S or 10BASE-T1L for long distances.

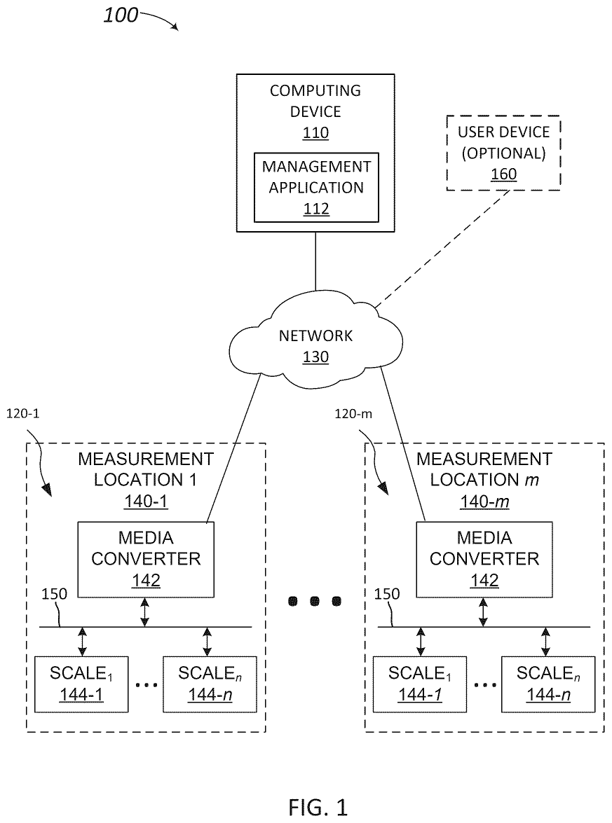

Referring to FIG. 1, an inventory management system 100 for networked scales, consistent with embodiments of the present disclosure, is described in greater detail. Although FIG. 1 shows only networked scales, other network connected objects may also be managed by system 100. In general, the inventory management system 100 includes network computing device 110 connected to a plurality of networked scale systems 120-1 to 120-m at a plurality of different measurement locations 140-1 to 140-m over a network 130 such as the internet. The inventory management system 100 may also include an optional user device 160 connected to network 130 for accessing the networked scale systems 120-1, 120-m and performing inventory management functions.

The network computing device 110 can be a standalone computing device, a management server, a web server, a mobile computing device, or any other electronic device or computing system capable of receiving, sending, and processing data. In an embodiment, the network computing device 110 can be a laptop computer, a desktop computer, or any programmable electronic device capable of communicating with other devices within system 100 via network 130. In another embodiment, the network computing device 110 can represent a server computing system utilizing multiple computers as a server system, such as in a cloud computing environment. In yet another embodiment, the network computing device 110 represents a computing system utilizing clustered computers and components (e.g., database server computers, application server computers) that act as a single pool of seamless resources when accessed within system 100.

In an embodiment, the network computing device 110 is a server hosting an inventory management application 112 (e.g., a Web app) to manage inventory at measurement location 140-1 through measurement location 140-m. In an embodiment, the inventory management application 112 is a program, application, or subprogram of a larger program for management of networked scales. In an embodiment, the inventory management application 112 may receive data from the networked scales, such as status, weights of products, and any other data that the networked scales may provide and use that data to manage the inventory. Other data may include, for example, inventory identifying data and date/time data. The inventory management application 112 may send this data to a user, e.g., the user of the user device 160, and may display the data on the UI of the user device 160.

The inventory management system 100 may be used to manage inventory at m measurement locations 140-1 to 140-m over the network 130 and the measurement locations 140-1 to 140-m may be different physical locations separated by distances. The network 130 can be, for example, a telecommunications network, a local area network (LAN), a wide area network (WAN), such as the internet, or a combination of the three, and can include wired, wireless, or fiber optic connections. The network 130 can include one or more wired and/or wireless networks that are capable of receiving and transmitting data, voice, and/or video signals, including multimedia signals that include voice, data, and video information.

In an embodiment, the network 130 may be a low-power wireless network, such as a mesh network. Examples of low-power, mesh networks may include, but are not limited to, Zigbee and Z-Wave networks. These low-power networks may allow devices such as scales to be powered by batteries rather than extracting power from the network or external power adapters. In general, network 130 can be any combination of connections and protocols that will support communications between the networked scale systems 120-1 to 120-m at the measurement locations 140-1 to 140-m and the network computing device 110.

The networked scale system 120-1, 120-m at each of the respective measurement locations 140-1, 140-m may include a media converter 142 connected to a plurality of scale devices 144-1 to 144-n over a 2-wire bus 150. The scale devices 144-1 to 144-n may be connected to the 2-wire bus 150 in a daisy chain configuration. The 2-wire bus 150 may carry both data and power and may supply power from the media converter 142 downstream to each of the scale devices 144-1 to 144-n in the daisy chain. Each of the scale devices 144-1 to 144-n may be a unique device and may have an individual address within the system 100. The networked scale systems 120-1, 120-m may be implemented using a 10BASE-T1 Ethernet standard, such as 10BASE-T1S or 10BASE-T1L, and the 2-wire bus 150 may include a single twisted pair. The networked scale devices 141-1 to 144-n may thus communicate directly with the network 130 (e.g., the internet) over an Ethernet/TCP connection and using a communication protocol such as Message Queuing Telemetry Transport (MQTT).

In some embodiments, the networked scale system 120-1, 120-m may include between 10 and 25, and more particularly between 20 and 25, scale devices 144-1 to 144-n connected to the 2-wire bus 150 and a single media converter 142. The maximum number of scale devices that may be included in a networked scale system at a measurement location may be limited by the amount of power that can be provided over the 2-wire bus, and any limitations on the number of devices supported by the protocol used over the 2-wire bus.

The user device 160 may be any user device capable of connecting to the network 130 and capable of providing a user interface, for example, a smartphone, a tablet computer, and the like. The user device 160 may provide a user interface, such as a graphical user interface (GUI) for accessing the inventory management application 112 and/or any one of the scale devices 144-1 to 144-n at any of the measurement locations 140-1 to 140-m to manage the inventory at the measurement locations 140-1 to 140-m.

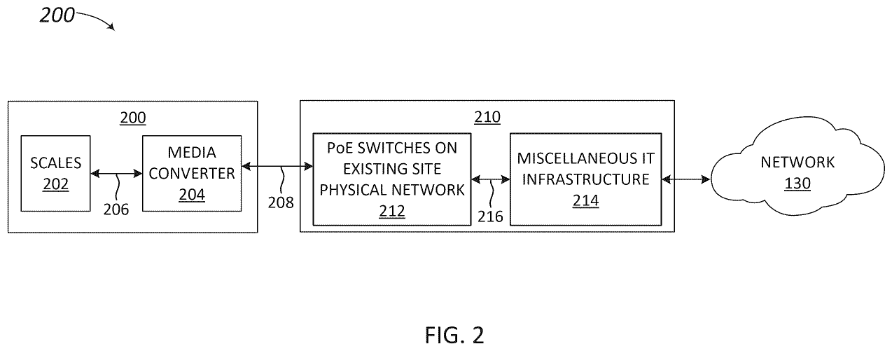

FIG. 2 is a functional block diagram illustrating a simplified networked scale system 200, consistent with an embodiment of the present disclosure. The networked scale system 200 includes a media converter 204 connected to a plurality of scale devices 202 in a daisy chain configuration via a 2-wire bus 206 that carries power and data, for example, as described above. The networked scale system 200 may be connected to existing communications infrastructure 210, for example, being used by a company or business at the location of the networked scale system 200, which is connected to the network 130 such as the internet. The existing communications infrastructure 210 may include, for example, power over Ethernet (PoE) switches 212 on an existing physical network and miscellaneous IT infrastructure 214, such as firewalls, routers, and/or any other networking infrastructure that may be included in the facility and managed by the local information technology staff. The PoE switches 212 provide communications and power to the media converter 204, which in turn provides communications and power to the scale devices 202. In an example using the 10BASE-T1S standard, the media converter 204 may include a power converter and a T1S chip to convert Ethernet into 10BASE-T1S.

The media converter 204 of the networked scale system 200 may be connected to one of the PoE switches 212 using a standard Ethernet/TCP connection 208, for example, using CAT6 cable and a CAT6 Ethernet drop from the PoE switch. The media converter 204 may connect directly to the network 130 (e.g., the internet) through the PoE switch and also connects to the daisy chain of scale devices 202. In one example, the media converter 204 has a T1S port that connects to the 2-wire bus 206 and a PoE port that connects to the Ethernet/TCP connection 208. By using low overhead in existing standard company IT infrastructure, this configuration thus provides a low-cost way to connect an array of internet-enabled scale devices 202 to the internet through a PoE switch without the use of an intermediate computer. This configuration also provides simplicity in managing a large array of networked scale devices 202 via the internet. In other embodiments, the media converter 204 may include an Ethernet switch and may include multiple Ethernet ports for interconnecting multiple media converters.

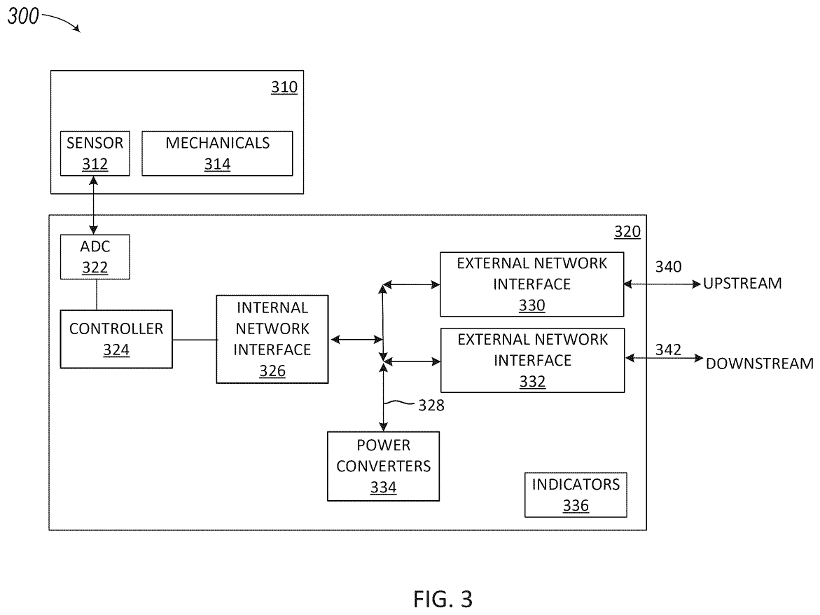

Referring to FIG. 3, an embodiment of a network-configured scale device 300, consistent with the present disclosure, is described in greater detail. The network-configured scale device 300 generally includes a measurement subsystem 310 and an electronics subsystem 320. The measurement subsystem 310 includes at least one sensor 312 to determine the mass of an inventory item to be weighed and scale mechanicals 314 for supporting the inventory item. One example of the sensor 312 is a strain gauge sensor or strain sensor. In some embodiments, the inventory item may include a pallet containing inventory, and the sensor 312 and mechanicals 314 may be configured to support and weight the pallet.

In this embodiment, the electronics subsystem 320 includes an analog to digital converter (ADC) 322, which converts the analog signal from sensor 312 to a digital signal, a controller 324, an internal network interface 326, and optional indicators 336. The network interface 326 may be connected to external network interface 330 and external network interface 332 over interconnect 328. It should be noted that while the example embodiment of FIG. 3 shows two interfaces, external network interface 330 and external network interface 332, this is for illustration only. In other embodiments the network-configured scale device 300 may have one interface, or more than two interfaces. In some embodiments, the internal network interface 326 may be coupled with optional power converters 334.

In an embodiment the internal network interface 326 is an Ethernet transceiver and the interconnect 328 is a 10BASE-T1S interface. The external network interface 330 may connect to an upstream device over connection 340, while the external network interface 332 may connect to a downstream device over connection 342. The power converters 334 may extract power from interconnect 328 to provide power for the network-configured scale device 300. The 10BASE-T1S specification allows for a DC bias on the data lines, since a 10BASE-T1S transceiver includes DC blocking. In an embodiment, the power converter 334 uses the DC bias to extract power for the network-configured scale device 300, along with the downstream scales.

In other embodiments, the external interfaces, such as external network interface 330 and external network interface 332, may interface to a low-power network, such as Zigbee or Z-Wave. In an embodiment, the external network interfaces, such as external network interface 330 and external network interface 332, may interface with any wired, wireless, or optical network as would be appropriate for the particular environment in which the network-configured scale device 300 is to be installed.

In other embodiments, the network-configured scale device 300 may be powered by one or more batteries. In these embodiments, the optional power converter 334 may be omitted, or may be configured to regulate the battery power as needed by the circuitry of the network-configured scale device 300.

In some embodiments the internal network interface 326 is an Ethernet switch and the interconnect 328 is an Ethernet interface. The network-configured scale device 300 may have one or more Ethernet interfaces, such as external network interface 330 and external network interface 332, based on the number of ports supported by the internal network interface 326. For example, if the internal network interface 326 is a six port Ethernet switch, then the scale 300 may have up to five external interfaces (since the sixth interface is the internal connection). In this embodiment, each external network interface may connect to any external Ethernet device, such as another scale.

The status of the scale 300 may be sent to the management application 112 and/or displayed on the indicators 336. The indicators 336 may be one or more light-emitting diodes (LEDs) or other light indicators. In some embodiments, a user may control the indicators 336 through the management application 112, for example, to blink an LED on clustered scales to allow a maintainer to locate all the scales in a group. In other embodiments, the indicators 336 may include a display, e.g., a liquid-crystal display (LCD), that may be capable of displaying a UI, e.g., a GUI, for inventory management or device status. In an embodiment, the UI of indicators 336 may work in conjunction with the UI on a user device, such as user device 160 from FIG. 1. In another embodiment, the UI of indicators 336 may work independently from any other UI.

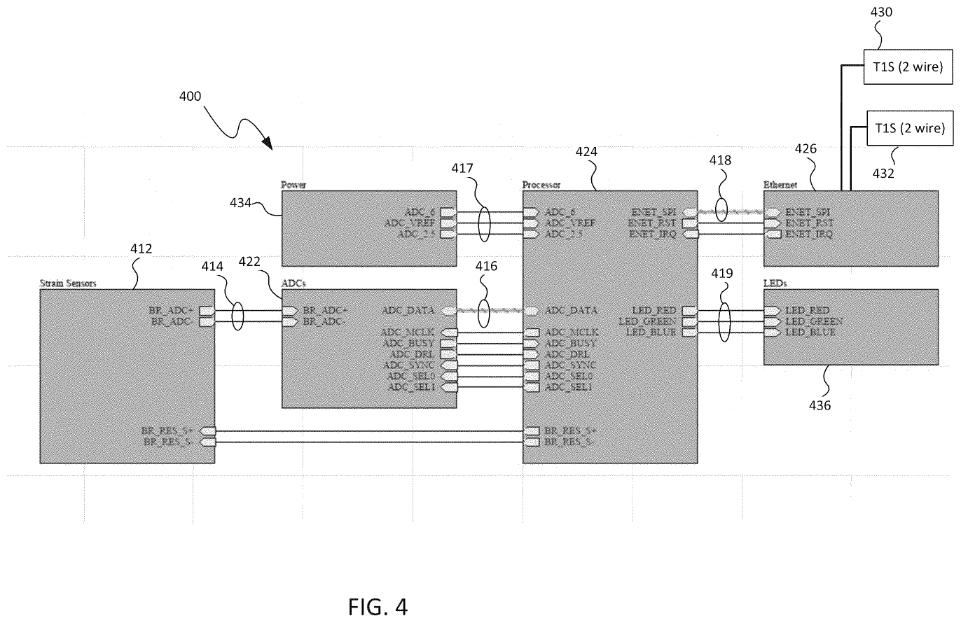

Referring to FIG. 4, another embodiment of a network-configured scale device 400, consistent with the present disclosure, is described in detail with electrical connections between the circuit components. In this example embodiment, the network-configured scale device 400 is configured to be connected using a 10BASE-T1S standard to a 2-wire bus in a daisy chain configuration with other scale devices and with a media converter, as described above. In this embodiment, the network-configured scale device 400 includes strain sensor circuitry 412, analog-to-digital converter (ADC) circuitry 422, a processor 424, Ethernet transceiver circuitry 426, an upstream connection 430, a downstream connection 432, power converter circuitry 434 and LEDs 436. As shown, the processor 424 is electrically connected to the strain sensor circuitry 412, the ADC circuitry 422, the Ethernet transceiver circuitry 426, the LEDs 436 and the power converter circuitry 434. The Ethernet transceiver circuitry 426 is electrically connected to the upstream connection 430 for receiving data and power from a scale device or a media converter connected upstream on the 2-wire bus. The Ethernet transceiver circuitry 426 is also electrically connected to the downstream connection 432 for providing data and power to any scale devices connected downstream on the 2-wire bus.

In one example, the strain sensor circuitry 412 may include, for example, a single point load cell with multiple strain gauges. The ADC circuitry 422 may include, for example, an ADC integrated circuit and the processor 424 may include, for example, a microcontroller unit (MCU). The Ethernet transceiver circuitry 426 may include a Media Access Controller (MAC) and Ethernet PHY configured to access a 10BASE-T1S network and configured to interface with a microcontroller using a Serial Peripheral Interface (SPI). The power converter circuitry 434 may include, for example, power converter modules, voltage references and voltage regulators configured to extract and convert power from the upstream connection 430 for supplying power at appropriate voltages to the electronic components of the scale. The ADC circuitry 422 may be electrically connected to the strain sensor circuitry 412 via ADC analog signal connections 414. The processor 424 may be electrically connected to the ADC circuitry 422 via an ADC digital data connection 416. The processor 424 may be electrically connected to the power converter circuitry 434 via power connections 417. The processor 424 may be electrically connected to the Ethernet transceiver circuitry 426 via Ethernet data connection 418. The processor 424 may be electrically connected to the LEDs 436 via LED connections 419.

According to one example of the operation of the network-configured scale device 400, the strain sensor circuitry 412 generates analog sensor signals representative of a mass of an item being weighed, such as an inventory item. The ADC circuitry 422 receives the analog sensor signals over the ADC analog signal connections 414 and converts the analog sensor signals to digital sensor signals representative of the mass of the item. The processor 424 receives the digital sensor signals over the ADC digital data connection 416 and processes the digital sensor signals to produce weight data including at least the measured weight of the item as determined by the strain sensor circuitry 422. The Ethernet transceiver circuitry 426 receives scale data, including the weight data, from the processor 424 over the Ethernet data connection 418 and transmits the data via the upstream connection 430 to the media converter (not shown) to allow the scale data to be accessed over the network.

Other configurations for the network-configured scale device are also contemplated and within the scope of the present disclosure.

Accordingly, an inventory management system, consistent with embodiments of the present disclosure, facilitates inventory management by using networked scales that are directly connected to the internet without the need for an edge gateway or interface PC. The networked scales at a particular measurement location may be connected in a daisy chain configuration to a 2-wire bus, which delivers data and power from a media converter to each of the networked scales and eliminates the need for power supplies or separate powering of the scale devices.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

The present disclosure may be a system and/or a method. The system may include one or more non-transitory computer readable storage media having computer readable program instructions thereon for causing a processor to carry out aspects of the present disclosure. The one or more non-transitory computer readable storage media can be any tangible device that can retain and store instructions for use by an instruction execution device. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An inventory management system comprising:
a first networked scale system located at a first measurement location, the first networked scale system comprising:
a first 2-wire bus configured to carry power and data at the first measurement location;
a first plurality of scales connected to the first 2-wire bus in a daisy chain configuration, wherein each of the first plurality of scales is configured to provide scale data including at least weight data representing weight of inventory items measured at the first measurement location; and
a first media converter connected to the first 2-wire bus and connected to a network via a first Ethernet connection, wherein the first media converter is configured to provide the scale data to the network and configured to provide power to the first plurality of scales via the first 2-wire bus;
at least a second networked scale system located at a second measurement location, the second networked scale system comprising:
at least a second 2-wire bus configured to carry power and data at the second measurement location;
at least a second plurality of scales connected to the second 2-wire bus in a daisy chain configuration, wherein each of the second plurality of scales is configured to provide scale data including at least weight data representing weight of inventory items measured at the second measurement location;
at least a second media converter connected to the second 2-wire bus and connected to the network via a second Ethernet connection, wherein the second media converter is configured to provide the scale data to the network and configured to provide power to the second plurality of scales via the second 2-wire bus; and
a network computing device connected to the network, the network computing device including a non-transitory machine-readable storage medium that includes instructions that, when executed by processor circuitry included in a portable electronic device, cause the processor circuitry to:
provide a user interface (UI) to allow a user to access the scale data; and
track inventory of one or more inventory items based on the scale data.

2. The inventory management system of claim 1, wherein the network is the internet.

3. The inventory management system of claim 1, wherein the first 2-wire bus and the second 2-wire bus carry power and data using a 10BASE-T1 standard, and wherein the first media converter and the second media converter each include a 10BASE-T1 port connected to the first 2-wire bus and the second 2-wire bus, respectively.

4. The inventory management system of claim 3, wherein the 10BASE-T1 standard is a 10BASE-T1S standard.

5. The inventory management system of claim 3, wherein the 10BASE-T1 standard is a 10BASE-T1L standard.

6. The inventory management system of claim 3, wherein the first media converter and the second media converter each include a power of ethernet (PoE) port connected to the first Ethernet connection and the second Ethernet connection, respectively, and wherein the first media converter and the second media converter convert between PoE and 10BASE-T1.

7. The inventory management system of claim 1, wherein each scale of the first and second plurality of scales comprises:
at least one sensor for sensing a mass of an inventory item;
an upstream connection connected to the 2-wire bus for receiving power and data from upstream on the 2-wire bus; and
a downstream connection connected to the 2-wire bus for providing power and data downstream on the 2-wire bus.

8. The inventory management system of claim 7, wherein each scale of the first and second plurality of scales further comprises:
an analog to digital converter (ADC) for converting analog sensor signals from the at least one sensor to digital sensor signals representative of the mass of the inventory item;
a processor for processing the digital sensor signals to produce at least weight data including at least a measured weight of the inventory item as determined by the sensor;
an Ethernet transceiver connected between the processor and the upstream connection and the downstream connection, wherein the Ethernet transceiver is configured to transmit and receive data via the upstream connection and the downstream connection using a 10BASE-T1 standard; and
at least one power converter configured to receive power from the upstream connection and configured to supply power to at least the ADC, the processor and the Ethernet transceiver.

9. The inventory management system of claim 1, wherein the network computing device comprises a server hosting a web application, and wherein the portable electronic device comprises a user device connected to the server via the network.

10. The inventory management system of claim 1, wherein the first plurality of scales and the second plurality of scales each include 10 to 25 scales.

11. A networked scale system comprising:
a 2-wire bus configured to carry power and data using a 10BASE-T1 standard;
a plurality of scales connected to the 2-wire bus in a daisy chain configuration, wherein each of the scales comprises:
at least one sensor for sensing a mass of an item;
an upstream connection connected to the 2-wire bus for receiving power and data from upstream on the 2-wire bus; and
a downstream connection connected to the 2-wire bus for providing power and data downstream on the 2-wire bus; and
a media converter including at least one 10BASE-T1 port connected to the 2-wire bus and at least one Ethernet port configured to be connected to an Ethernet connection, wherein the media converter converts between standard Ethernet and 10BASE-T1 and provides power to the plurality of scales over the 2-wire bus.

12. The networked scale system of claim 11, wherein the 10BASE-T1 standard is a 10BASE-T1S standard.

13. The networked scale system of claim 11, wherein the 10BASE-T1 standard is a 10BASE-T1L standard.

14. The networked scale system of claim 11, wherein the plurality of scales includes 10 to 25 scales.

15. The networked scale system of claim 11, wherein the at least one Ethernet port includes a power over ethernet (PoE) port, and wherein the media converter converts between PoE and 10BASE-T1.

16. The networked scale system of claim 11, wherein each of the scales further comprises:
an analog to digital converter (ADC) for converting analog sensor signals from the at least one sensor to digital sensor signals representative of the mass of the item;
a processor for processing the digital sensor signals to produce at least weight data including a measured weight of the item as determined by the sensor;
an Ethernet transceiver connected between the processor and the upstream connection and the downstream connection, wherein the Ethernet transceiver is configured to transmit and receive data via the upstream connection and the downstream connection using a 10BASE-T1 standard; and
at least one power converter configured to receive power from the upstream connection and configured to supply power to at least the ADC, the processor, and the Ethernet transceiver.

17. A network configured scale device, comprising:
at least one sensor for sensing a mass of an item and for generating analog sensor signals representative of the mass of the item;
an analog to digital converter (ADC) for converting the analog sensor signals to digital sensor signals representative of the mass of the item;
a processor for processing the digital sensor signals to produce at least weight data including a measured weight of the item as determined by the sensor;
an upstream connection configured to be connected to a 2-wire bus that carries power and data using a 10BASE-T1 standard;
a downstream connection configured to be connected to the 2-wire bus;
an Ethernet transceiver connected between the processor and the upstream connection and the downstream connection, wherein the Ethernet transceiver is configured to transmit and receive data via the upstream connection and the downstream connection using a 10BASE-T1 standard; and
at least one power converter configured to receive power from the upstream connection and configured to supply power to at least the ADC, the processor and the Ethernet transceiver.

18. The network configured scale device of claim 17, wherein the 10BASE-T1 standard is a 10BASE T1S standard.

19. The network configured scale device of claim 17, wherein the 10BASE-T1 standard is a 10BASE T1L standard.

20. The network configured scale device of claim 17, wherein the at least one sensor includes at least one strain gauge sensor.
